(19) United States
(12) Patent Application Publication
(10) Pub. No.: US 2009/0085000 A1
(43) Pub. Date: Apr. 2, 2009

(54) Electrocoated valve components and methods of manufacturing the same

(76) Inventors: Thomas Daniel Buerkle, Sandusky, MI (US); Charles Burton Dumaw, Deckerville, MI (US); Scott Allen Weickel, Highland, MI (US)

Correspondence Address: REISING, ETHINGTON, BARNES, KISSELLE, P.C., P O BOX 4390, TROY, MI, 48099-4390, US

(21) Appl. No.: 11/906,427

(22) Filed: Oct. 2, 2007

(51) Int. Cl. F16K 27/00; B05D 1/04; B05D 3/00

(52) U.S. Cl. 251/368; 427/532

(57) ABSTRACT

A valve component may include a polyurethane coating electrocoated thereon. The polyurethane coating is a hard, smooth, and lubricious coating that facilitates low frictional engagement with one or more elastomeric seals. To make a valve component with such a coating, the valve component may be electrocoated in an emulsion comprising suspended polyurethane particles while being moved in a predetermined motion.

### TECHNICAL FIELD

This invention relates generally to coated valve components and methods of manufacturing the same.

### BACKGROUND OF THE DISCLOSURE

Valve components are oftentimes treated to improve operational durability prior to final assembly. For example, anodizing is a popular and widely implemented treatment performed on various metal components and is characterized by modifying the natural surface oxide layer present thereon. Anodizing generally includes immersing the valve components as anodes into a heated sulfuric acid bath and applying a direct current between the components and one or more immersed metal articles constituting a cathode. One problem associated with anodizing is the storage, handling, and disposal of considerable amounts of sulfuric acid. Following anodization, the valve components traditionally undergo additional process steps including, but not limited to, masking, sealing, and painting.

Nevertheless, alternative methods for treating valve components are continuously being researched and investigated in an effort to bring valve components to the market that exhibit a variety of operational characteristics and capabilities.

### SUMMARY OF THE DISCLOSURE

One embodiment of a valve component may be a metal valve body that defines at least one bore for slidably receiving a valve member. One or more elastomeric seals may form a seal between the bore and the valve member. The at least one bore has a polyurethane coating electrocoated thereon.

One embodiment of a valve assembly includes a metal valve component defining at least one bore and a metal valve member surrounded by the bore and operably slidably received therein. One or more elastomeric seals may be affixed to one of the bore or the valve member to form a seal therebetween. The other of the valve bore or the valve member may have a surface polyurethane coating electrocoated thereon for engagement with the one or more elastomeric seals.

Another embodiment of a valve assembly includes a metal valve component defining at least one bore. The valve body and the at least one bore have a polyurethane coating electrocoated thereon. A valve member may be received in the bore and may included at least one elastomeric seal disposed around its periphery for forming a seal therebetween.

One embodiment of a method may include electrocoating one or more valve components each defining at least one bore. The valve components may be electrocoated in an emulsion comprising suspended polyurethane particles while the one or more valve components or the emulsion are moved in a predetermined motion with respect to each other.

Another embodiment of a method may include carrying one or more valve components in a carrier. The one or more valve components may be at least partially immersed in an emulsion having suspended polyurethane particles. The one or more valve components may serve as cathodes and may be moved in a predetermined motion by the carrier. An electric current may be supplied through the emulsion between the one or more valve components and one or more anodes.

### BRIEF DESCRIPTION OF THE DRAWINGS

Reference now is made to the accompanying drawings in which:

FIG. 1 is a cross-sectional view of a valve component in accordance with one embodiment of the invention.

FIG. 2 is flowchart depicting some of the steps for forming a valve component with a polyurethane coating electrocoated thereon.

### DETAILED DESCRIPTION OF THE PREFERRED EMBODIMENT

In general, and before referring to the drawings, a valve assembly includes a valve component with a bore and a valve member for operable engagement with the bore. One of the bore or the valve member has a surface polyurethane coating electorcoated thereon. Electrocoating may be, in some manufacturing, applications, a viable alternative to traditional valve treatment techniques that may include, for example, anodizing, masking, and painting. The term valve component is intended to cover any valve or regulator related article having a bore that sealingly receives a valve member therein, and also a valve member to be received in the bore. For example, in various embodiments, the valve component is a metal valve body defining at least one bore that receives a valve member with an elastomeric seal thereon. Examples of valves comprising such valve components include, but are not limited to, spool valves, poppet valves, and lock-out valves, to name but a few. In instances such as these, a thin polyurethane coating is electrocoated onto at least the surface of the bore or the valve member in the bore. The polyurethane coating provides a smooth and lubricious surface for the elastomeric seal to rest against and also protects the valve body and the valve member's susceptibility to corrosion, wear, and chemical attack. Besides valves bodies, other examples of valve components that may be electrocoated with polyurethane coating include devices such as regulator housings.

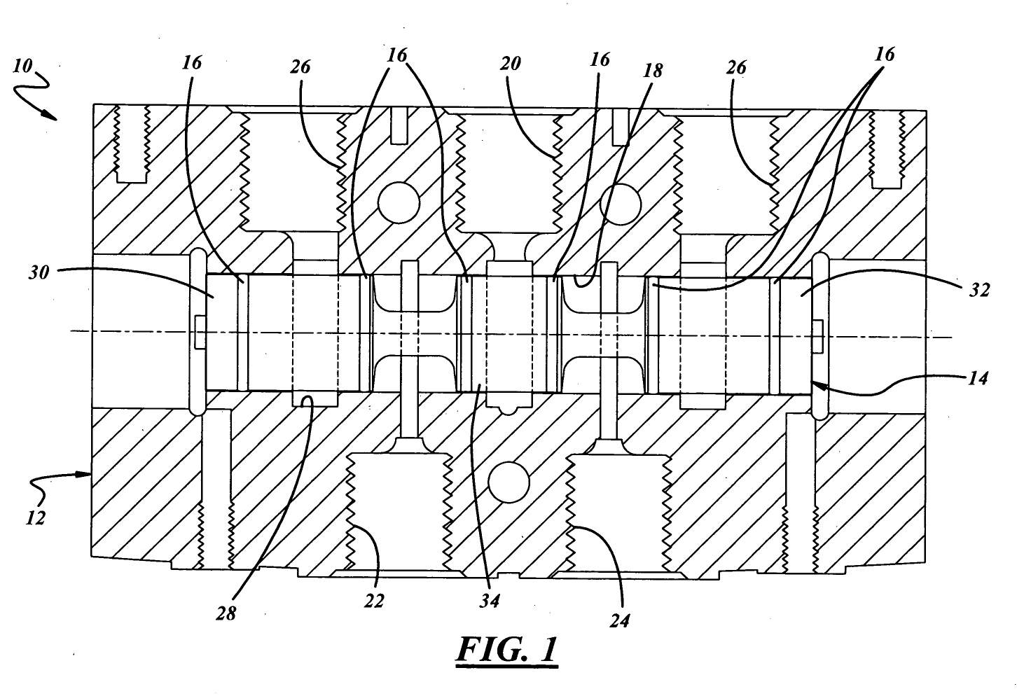

Referring now to FIG. 1, a 3 position 5-way spool valve 10 for controlling the distribution of a pneumatic fluid such as air, or a hydraulic fluid, is shown generally as an exemplary embodiment. Consequently, those skilled in the art will understand that the spool valve shown is merely illustrative in nature and that the scope of the invention is not limited to this particular spool valve construction, or even solely to spool valves, as mentioned above.

In the embodiment shown in FIG. 1, the spool valve 10 includes a valve body 12 and a spool 14. The spool 14 carries one or more elastomeric seals 16 thereon. The spool valve 10 may be configured to cooperate with a variety of known devices such as, for example, a modular multiple output pneumatic pressure valve. Those skilled in the art however will appreciate that many different types of devices may cooperate with the spool valve 10.

The valve body 12 houses the internal components of the spool valve 10 and may be constructed from a metal such as aluminum, magnesium, zinc, or alloys comprising at least one of these metals. The valve body 12 defines at least one bore 18 in fluid communication with a plurality of ports, as is well known in the art. In the embodiment shown, the bore 18 is generally cylindrically shaped and is coextensive with the length of the body 12. An inlet port 20 is centrally located on one side of the bore 18 for introducing pneumatic fluid therein. A first cylinder port 22 and a second cylinder port 24 are positioned on the opposite side of the bore 18 and allow pneumatic fluid to discharge therefrom. Situated on each side of the inlet port 20 are exhaust ports 26 for the pneumatic fluid. Additionally, annular grooves 28 may be defined in the bore 18 and coupled with the ports to facilitate the flow of pneumatic fluid. Those skilled in the art will appreciate and understand that the arrangement and number of inlet ports, outlet ports, and exhaust ports may be modified without changing the fundamental functionality of the spool valve 10.

The surface of the valve body 12, including the bore 18, may be electrocoated with a polyurethane coating to enhance the life of the spool valve 10, as previously mentioned. During the electrocoating process, which will be described in greater detail below, charged polyurethane particles coagulate onto the surface of the valve body 12 to form a thin coating between about 0.0002 inches and 0.001 inches thick. The coating is sufficient to smooth out any surface imperfections resulting from routine machining. Also, the throwing power inherent in the electrocoating process helps assure a coating of uniform thickness exists on the entire exposed surface of the valve body 12. The term throwing power describes the tendency of charged particles to uniformly coat the valve body 12 by seeking out the points of greatest opposite attraction. In one embodiment, the valve body 12 may be electrocoated with a cathodic electrocoating resin such as CLEARCLAD HSR, which is distributed as a base resin concentrate by CLEARCLAD Coatings, Inc. of Harvey, Ill. Those skilled in the art will appreciate, however, that similar outcomes may be achieved with other commercially available cathodic electrocoating resins besides CLEARCLAD HSR. Moreover, the valve body 12 may instead be electrocoated with an anodic electorcoating resin, if desired.

The electrodeposited polyurethane coating derived from CLEARCLAD HSR is a hard, smooth, and lubricious coating that is conducive to frictional engagement with the one or more elastomeric seals 16. Additionally, the polyurethane coating as formulated affords a high degree of abrasion and wear resistance as well as strong chemical, corrosion, and UV light resistance. As such, these demonstrated characteristics render an electrodeposited polyurethane coating a suitable alternative to anodizing the valve body 12, thus eliminating some of the problems associated with anodizing.

Furthermore, the electrocoated polyurethane coating may be pigmented and/or otherwise modified to resemble a variety of colors, for example, gray, yellow, black, and appearances such as a glossy or matte finish. This option provides a mechanism for manufacturing a valve body 12 of a particular color and appearance without relying on conventional valve painting and finishing techniques, such as spray painting. In fact, the utilization of a pigmented polyurethane coating in lieu of a conventional painting process may be an attractive opportunity in some instances to avoid issues such as excess spraying, handling and masking, etc.

The spool 14 is slidingly received in the bore 18 and comprises a plurality of lands separated by sections of reduced diameter. In the embodiment shown, the spool comprises a first land 30, a second land 32, and a third land 34 therebetween. The position of the lands 30, 32, 34 with respect to the inlet port 20, cylinder ports 22, 24, and exhaust ports 26 governs the flow of pneumatic fluid through the spool valve 10 and hence the distribution of pneumatic fluid therefrom. The position of the spool 14 within the bore 18 may be controlled by a number of conventional mechanisms known in the art, such as, but not limited to, solenoid actuation and spring biasing of the spool 14. Those skilled in the art will know the general operation, arrangement, and functions of this spool valve 10, including the function of the spool 14 and its relationship to pneumatic fluid flow, so that a more complete description need not be given here.

The one or more elastomeric seals 16 are disposed around each land 30, 32, 34 to form a seal with the bore 18. As shown here, each land 30, 32, 34 comprises a pair of axially spaced and radially inwardly embedded annular grooves 36 each configured to receive its respective elastomeric seal 16. The seals 16 protrude slightly circumferentially beyond the surface of the lands 30, 32, 34 to form a dynamic seal with the bore 18 to prevent pneumatic fluid from bleeding therebetween. The seals 16 of this embodiment are conventional O-ring seals that may be composed of any known material such as the various thermosets and thermoplastics conventionally used in industry. Of course, skilled artisans will appreciate that numerous other seal arrangements are known and that the one described is merely exemplary in nature.

As alluded to above, the electrocoated polyurethane coating has been shown to reduce the effects of frictional interaction between the bore and the seals. For example, a 21 mm prototype spool valve similar to the one shown here has successfully completed over 39 million cycles without failure of the seals.

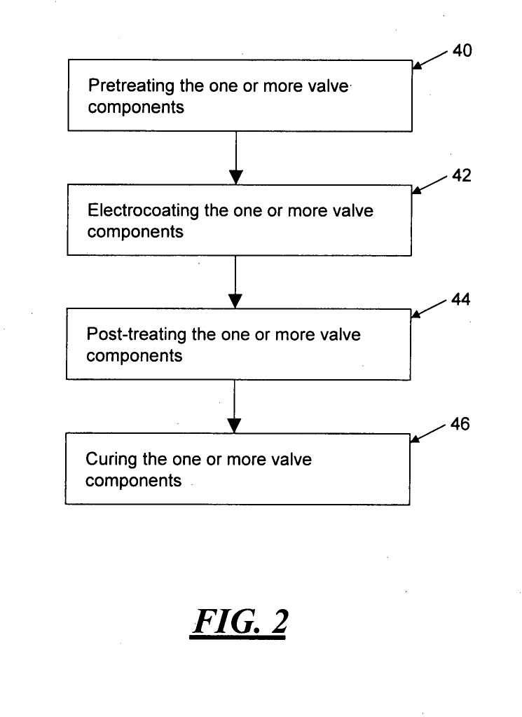

Referring now to FIG. 2, one method of manufacturing valve components with an electrocoated polyurethane coating may generally include first loading one or more valve components onto a carrier in a predetermined arrangement. Then, the carrier intermittently progresses through a tankline constructed to include a pretreating step 40, an electrocoating step 42, and a post-treating step 44. Afterwards, the electrocoated polyurethane coatings on the one or more valve components are cured in a curing step 46. Following curing, the one or more valve components are unloaded and the carrier is repositioned to receive a new load of components. More or less steps may be included in the process as understood by those skilled in the art. This process may be partly or entirely automated. For instance, temperature controls, level controls, and the like, as well as all appropriate sensors may be incorporated into the system as is understood by those skilled in the art. One company that supplies such control systems and accompanying software for automating the process is Adroit Automation, Inc. of Tucson, Ariz.

The carrier itself is preferably constructed to releasably receive the one or more valve components in a predetermined arrangement according to, among other considerations, size, shape, and weight of the components. The carrier is further constructed to rotate or otherwise move, if desired, the one or more valve components to facilitate their exposure while immersed. Moreover, the carrier is also constructed for operable engagement with a conventional framework, track, or conveyor that guides the carrier through the tankline. More than one carrier may be progressing through the tankline in order to increase the output of valve components per unit of time.

The tankline may be described as an arrangement of tanks each dedicated to a predetermined purpose. In this embodiment, at least one tank is dedicated to pretreating the one or more valve components, at least one tank is dedicated to electrocoating the one or more valve components, and at least one tank is dedicated to post-treating the one or more valve components. For the above described valve components, the tanks may be similarly sized with a height of about 42 inches, an internal measurement parallel to the carrier's movement of about 24 inches, and an internal measurement transverse to the carrier's movement of about 48 inches. The tanks may be filled to a liquid level of about 38 inches to ensure that, when the carrier is received, the one or more valve components secured thereon can be completely immersed if required. The tanks may be constructed from stress relieved gray polypropylene and are supported, if necessary, with encapsulated steel reinforcements. Also, situated around the opening of each tank may be a tank flange. Polypropylene saddles with auxiliary contacts or cast machined bronze saddles may be mounted to the tank flange and constructed to receive and support the carrier at one or more positions. Additionally, the saddles may provide an electrical contact for supplying the carrier with the power necessary to rotate the valve components while immersed, if so desired. The individual tanks of the tankline may also be fitted or operably engaged with pumps, filters, recirculation equipment, wastewater treatment equipment, and all other conventional process equipment as is known to those skilled in the art.

During the pre-treatment step 40, the one or more valve components are prepared for electrocoating. In this embodiment, the one or more valve components are cleaned, cascade rinsed, and exposed to a wetting agent in separate tanks or a separate series of tanks. One way to clean the one or more valve components is to soak-clean them in a tank filled with an appropriate and commercially available cleaning solution that is maintained at a temperature between about 110° F. and about 120° F. The temperature of the cleaning solution is controlled by an immersed electric heater, but other options are available. Furthermore, the cleaning solution may be filtered by way of a circulation pump and filter to ensure contaminates that may reduce the solution's effectiveness do not accumulate therein. The tank utilizes polypropylene saddles with auxiliary contacts. Other cleaning options available as an alternative or in combination to soak-cleaning include electrocleaning, ultrasonic cleaning, aqueous degreasing, vapor degreasing, solvent cleaning, diphase cleaning, and mechanical cleaning, to name but a few.

After cleaning, the one or more valve components are cascade rinsed with deionized water in a first rinse tank and second rinse tank. That is, the tanks are coupled so that fresh deionized water is supplied to the second rinse tank which, in turn, delivers its contents to the first rinse tank. Thus, the flow of deionized water between the first rinse tank and the second rinse tank is counter to the direction in which the carrier is progressing through the tankline. The water in the first tank is ultimately filtered via a circulation pump and filter, and then returned to the second rinse tank. In this embodiment, the temperature of the deionized water in the second tank is maintained at ambient temperature and the deionized water in the first rinse tank is maintained between about 80° F. and about 90° F. The first rinse tank and the second rinse tank both utilize polypropylene saddles with auxiliary contacts. Of course, various alternative rinsing options may be substituted for or combined with this cascade rinsing embodiment such as the use of additional or fewer rinse tanks, spray rinsing, or misting, to name but a few.

After rinsing, the one or more valve components are exposed to an appropriate wetting agent to enhance the ability of various liquids to spread across the surface of the one or more valve components. In this embodiment, the one or more valve components are received in a tank filled with a solution of deionized water containing 0.1% Rinse-Aid, which is a wetting agent available from CLEARCLAD Coatings, Inc. To reliably maintain this concentration of Rinse-Aid, the solution's conductivity is measured and, if necessary, calculated amounts of water and/or Rinse-Aid are added via separate sources. The temperature of the solution is maintained between about 80° F. and about 90° F. and is controlled by an immersed electric heater, although other options are available. Similar to before, the solution here may be filtered by way of a circulation pump and filter to ensure contaminates do not accumulate therein. Moreover, the tank utilizes polypropylene saddles with auxiliary contacts.

During the electrocoating step 42, the one or more valve components are coated with the polyurethane coating while immersed in an emulsion under the influence of an electric current. In this embodiment, the emulsion is formed in a tank by gradually diluting a base resin concentrate of CLEARCLAD HSR with deionized water while stirring. The emulsion is diluted to a solids content of less than about 18%, but this composition may vary. Additionally, a solvent such as CLEARCLAD Emulsion Stabalizer, also available from CLEARCLAD Coatings, Inc., may be introduced into the emulsion during dilution and subsequently maintained therein to facilitate emulsification. Likewise, the emulsion is continuously agitated by stirring, recirculation pumps, or the like in order to further promote and preserve the emulsion. The operational temperature of the emulsion is generally between about 70° F. and about 85° F. and is controlled by an integrated chiller and heat exchanger. In operation, the emulsion may be filtered by way of a circulation pump and filter, and any recovered solids may be recycled back into the tank. This ultimately reduces process waste and conserves CLEARCLAD HSR concentrate that would otherwise be used to resupply the tank.

Once immersed, the one or more valve components are configured as cathodes. Disposed on the tank sides are one or more at least partially immersed anodes constructed from 316 stainless steal. A voltage of between about 10V to 150V is applied between the one or more valve components serving as cathodes and the anodes to achieve a current density of up to about 3.0 amps/ft². And, as is understood by those skilled in the art, the current density is inversely proportional to the thickness of the polyurethane coating being electrocoated onto the one or more valve components. In other words, at a constant voltage, the current density decreases as the thickness of the coatings increase. Indeed, the thickness of the polyurethane coating can be controlled by observing the current density as an indicator of coating thickness and adjusting the voltage accordingly. For example, depending on a number of factors including the voltage utilized, a polyurethane coating ranging from about 0.0002 inches to about 0.001 inches thick is generally obtainable in about 50 to 130 seconds.

Also, as previously mentioned, the carrier continuously rotates the one or more valve components during electrocoating. The tank utilizes bronze saddles to receive and supply power to the carrier. This rotation, or movement in general, helps ensure that the one or more valve components are uniformly electrocoated and that no hidden or blind spots remain exposed. In other words, the rotation or movement of the one or more valve components supplements the throwing power inherent in the electrocoating process by enhancing exposure of certain areas of component(s) to the emulsion, such as small and/or hidden cavities and crevices, threaded regions, highly contoured surfaces, and the like.

During the post-treatment step 44, excess or loose emulsion accumulated on the one or more valve components, also referred to as drag-out, is removed therefrom. In this embodiment, the carrier is received in a drag-out rinse tank filled with deionized water that further includes a spray nozzle axially spaced and circumferentially mounted to the tank flange. The spray nozzle is configured to spray fresh deionized water inward as the carrier is lowered into and hoisted from the tank. As such, the drag-out is removed from the one or more valve components and discarded into the water in the tank. The tank contents are ultimately filtered with the drag-out free deionized water returned to the tank. Additonally, the drag-out which is filtered from the deionized water is recycled back to the electrocoating tank to reduce costs and the generation of unnecessary waste. The drag-out rinse tank utilizes polypropylene saddles with auxiliary contacts. Of course, other means for removing drag-out are known to those skilled in the art, and include, for example, draining or rinsing the plurality of valve components directly above the electrocoating tank.

During the curing step 46, the polyurethane coating on the one or more valve components is cross-linked and hardened to assure maximum performance properties are achieved. In this embodiment, the electrocoated polyurethane coatings are pre-warmed and cured by gas fired infrared heaters, and then cooled. The coatings are pre-warmed to evaporate residual water contained in the coating. For example, the one or more valve components may be pre-warmed for approximately 10 minutes at a temperature of about 210° F. Next, the coatings are cured. For example, the one or more valve components may be heated for approximately 25 minutes at a temperature ranging from about 375° F. to about 400° F. Finally, the one or more valve components having cured polyurethance coatings thereon are cooled by one or more fans. At this point, the one or more valve components may be unloaded from the carrier and utilized in whatever manner is deemed appropriate. It will be appreciated by those skilled in the art that other curing mechanisms are available, such as exposure to ultraviolet light. Furthermore, the process variables disclosed above may vary based on a number of factors including, among others, the composition and thickness of the polyurethane coating.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

The embodiments in which an exclusive property or privilege is claimed are defined as follows:

1. A valve component comprising:
a metal valve body defining at least one bore for receiving a valve member, and
a polyurethane coating electrocoated on the at least one bore for slidably receiving the valve member in the bore.

2. The valve component as defined in claim 1 wherein the entire valve body has the polyurethane coating electrocoated thereon.

3. The valve component as defined in claim 1 wherein the body is constructed from aluminum, magnesium, zinc, or alloys composed of at least one of these metals.

4. The valve component as defined in claim 1 wherein the polyurethane coating is between about 0.0002 inches to about 0.001 inches thick.

5. The valve component as defined in claim 1 wherein the polyurethane coating is pigmented.

6. A valve assembly comprising:
a metal valve component defining at least one bore having a polyurethane coating electrocoated on the at least one bore;
a valve member received in the at least one bore; and
at least one elastomeric seal disposed around a periphery of the valve member and engaging the polyurethane coating to form a seal between the valve member and the bore.

7. The valve of claim 6 wherein the valve component is constructed from aluminum, magnesium, zinc, or alloys composed of at least one of these metals.

8. A valve assembly comprising:
a metal valve component defining at least one bore:
a metal valve member surrounded by the bore and operably slidably received therein;
one or more elastomeric seals carried by one of the bore or the valve member to form a seal therebetween, the other having a surface polyurethane coating electrocoated thereon for engagement with the one or more elastomeric seals.

9. The valve assembly as defined in claim 8 wherein the bore is electrocoated with the surface polyurethane coating and the one or more elastomeric seals are disposed around a periphery of the valve member.

10. The valve assembly as defined in claim 9 wherein the polyurethane coating is between about 0.0002 and 0.001 inches thick.

11. A method of making valve components, the method comprising:
providing one or more valve components, each defining at least one bore;
electrocoating the one or more valve components in an emulsion comprising suspended polyurethane particles to form a polyurethane coating thereon; and
moving, in a predetermined motion, the one or more valve components or the emulsion with respect to the other such that the one or more valve components and the at least one bore are essentially uniformly coated with the polyurethane particles.

12. The method of claim 11 wherein the electrocoating is cathodic electrocoating.

13. The method of claim 11 wherein the electrocoating forms the polyurethane coating between about 0.0002 inches and about 0.001 inches thick.

14. The method of claim 11 further comprising, before the electrocoating step and in order:
soak-cleaning the one or more valve components;
cascade rinsing the one or more valve components valve components in deionized water; and
exposing the one or more valve components to a wetting agent.

15. The method of claim 11 further comprising after the electrocoating step and in order:
removing drag-out from the one or more valve components, and
curing the polyurethane coating.

16. The method of claim 15 wherein the curing step further comprises:
heating, for a predetermined time, the polyurethane coating at a temperature where water is evaporated therefrom but cross-linking is not induced; and
heating, for a predetermined time, the polyurethane coating at a temperature where cross-linking is induced.

17. The method of claim 11 wherein providing the one or more valve components comprises providing valve components constructed from aluminum, magnesium, zinc, or alloys composed of at least one of these metals.

18. The method of claim 11 further comprising:
providing a carrier constructed to carry the valve components and to further move the valve components in the predetermined motion.

19. The method of claim 18 wherein providing the carrier includes rotating the valve components.

20. A valve component manufactured according to claim 11.

21. A method of making valve components, the method comprising:
carrying one or more valve components in a carrier;
at least partially immersing the one or more valve components in an emulsion comprising suspended polyurethane particles, each of the one or more valve components serving as a cathode;
using the carrier to move the one or more valve components in the emulsion;
supplying electric current through the emulsion between the cathodes and one or more anodes so that the polyurethane particles adhere to the one or more valve components and form a polyurethane coating thereon; and
curing the polyurethane coating.

22. The method of claim 21 further comprising:
soak-cleaning the one or more valve components;
cascade rinsing the one or more valve components in deionized water;
exposing the one or more valve components to a wetting agent; and
removing drag-out from the one or more valve components and returning the drag-out to the emulsion.

23. The method of claim 21 wherein using the carrier to move the one or more valve components comprises rotating the one or more valve components.

24. The method of claim 21 wherein the supplying of the electric current forms the polyurethane coating between about 0.0002 inches and about 0.001 inches thick.

25. The method of claim 21 further comprising providing one or more valve components constructed from aluminum, magnesium, zinc, or alloys composed of at least one of these metals.
